(19) United States
(12) Patent Application Publication
(10) Pub. No.: US 2016/0234556 A1
(43) Pub. Date: Aug. 11, 2016

(54) System and Method for Organizing, Ranking and Identifying Users as Official Mobile Device Video Correspondents

(71) Applicant: Fan Media Network, Inc., Dallas, TX (US)

(72) Inventor: Kirk Berridge, Dallas, TX (US)

(21) Appl. No.: 14/619,835

(22) Filed: Feb. 11, 2015

(51) Int. Cl. H04N 21/475; H04N 21/4788; H04N 21/442; H04N 21/845; H04N 21/81; H04N 21/2743; H04N 21/431; G06Q 30/02; H04N 21/414

(52) U.S. Cl. CPC H04N 21/4758; G06Q 30/0201; H04N 21/4788; H04N 21/44213; H04N 21/44222; H04N 21/41407; H04N 21/8126; H04N 21/2743; H04N 21/4312; H04N 21/8456

(57) ABSTRACT

A system and a method organizing, ranking and identifying users as official mobile phone correspondents are disclosed. In some embodiments a computer-implemented method is performed on a computing device and includes collecting content quality data for a plurality of users, wherein the content quality data for each user is calculated from the following content quality measures: (1) a number of videos made by the user, (2) a number of positive votes received for the videos made, (3) a number of views for the videos made, (4) a number of times the videos made is shared by other users, (5) a number of other users following the user, and determining and ranking the plurality of users according to the collected content quality data.

### TECHNICAL FIELD

The present invention generally relates to a system and method for organizing users or sports fans through a hand held device application. The present invention also relates to a system and method for building a network of users or sports fans for professional and collegiate sports teams by identifying, ranking and promoting the users or sports fans. The present invention finally relates to a system and method for collecting and organizing videos.

### BACKGROUND

Current sports reporting services typically utilize television, radio, newspaper and Internet compatible devices. The television, radio and newspaper media typically select their correspondents through the conventional recruiting and human resources processes. The applicants for jobs on-camera typically come through referrals or are found at other media companies or colleges having studied the related subject matter. Viewers do not get a vote in determining who is appointed as media correspondents. Furthermore, little information is available and can be tracked about their likability and credibility.

### SUMMARY

In accordance with an embodiment of the present invention, a computer-implemented method, the method being performed on a computing device and comprising collecting content quality data for a plurality of users, wherein the content quality data for each user is calculated from the following content quality measures (1) a number of videos made by the user, (2) a number of positive votes received for the videos made, (3) a number of views for the videos made, (4) a number of times the videos made is shared by other users, and (5) a number of other users following the user, and determining and ranking the plurality of users according to the collected content quality data.

In accordance with an embodiment of the present invention, a method for operating a computing device, the method being performed by a processor and comprising producing a video clip of an event of a team via a camera of the computing device, uploading as part of an application that runs on the computing device, via an input device, the video clip to a server, displaying a user interface as part of the application, on a display unit, image data related to the uploaded video clip, wherein the user interface includes a first panel and a second panel, wherein the image data is displayed in the first panel when the user is an official mobile device video correspondent and when the video clip was uploaded as a latest video clip, and wherein the image data is displayed in the second panel when the user is not an official mobile device video correspondent and when the video clip receives more views from a plurality of users than other video clips made with respect to the same team.

In accordance with an embodiment of the present invention, a computer-implemented method, the method being performed on a computing device and comprising collecting content quality data for a plurality of users, wherein the content quality data for each user is calculated from the following content quality measures: (1) a number of videos made by the user, (2) a number of positive votes received for the videos made, (3) a number of views for the videos made, (4) a number of times the videos made is shared by other users, and (5) a number of other users following the user, and collecting activity data for the plurality of users, wherein the activity data for each user is calculated from the following activity measures: (6) a number of times the user has opened an application that runs on the users computing device, (7) a time spent the application, (8) a number of videos viewed, (9) a number of videos voted on, (10) a number of videos shared, (11) a number of other users the user followed. The method further comprises calculating performance data for each user based on the content quality data and activity data, and determining and ranking the plurality of users according to the collected performance data.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1a shows a block diagram illustrating an embodiment of a network arrangement with a sports fan taking a video from a sports event;

FIG. 1b shows a block diagram illustrating an embodiment of a network with hand held devices running applications for sports media services, devices running administrative applications for sports media services, and servers;

FIG. 1c shows a block diagram illustrating an embodiment of an application program for sports media services operated on a hand held device;

FIG. 1d shows a block diagram illustrating an embodiment of an administrative application program for sports media services operated on a hand held device;

FIG. 2 shows an embodiment of a flow chart for selecting an official mobile device video correspondent;

FIGS. 3a-3f shows embodiments of different user interfaces of the application for sports media services running on a hand held device;

FIG. 4a shows an embodiment of a user interface of the administrative application for sports media services showing activities for the different professional or collegiate sports teams; and

FIG. 4b shows an embodiment of a user interface of the administrative application for sports media services for ranking official mobile device video correspondents for an individual sports team.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to embodiments in a specific context, namely a flow chart for selecting an official mobile device video correspondent. The invention may also be applied, however, to other selection processes.

Traditional on-camera media jobs are reserved for a chosen few. The television stations, radio stations or newspaper publishers typically select their correspondents through the conventional recruiting and human resources processes which are limited by the amount of time for reviewing each applicant or by biases inherent in these selection processes. The viewers historically have not been included in these selection processes. Embodiments of the present invention remove and lower barriers of entry for the mainstream public or sports fans to become or to act as a professional media producer, for example, as a news reporter/correspondent. An advantage of embodiments of the method is that viewers get to determine/vote who their media correspondents are. Sports fans can be easily discovered by Fan Media Network and other media companies. A further advantage is that the sports fan can increase his “rank” and “status” in social media. A yet another advantage is that the sports fans are enabled to provide organized, creative, innovative, insightful, most current and up-to-date news reporting, commentary and criticism.

Embodiments of the invention provide high quality media content to the public and the sports fans for low cost. An advantage is that the cost for producing traditional television media using expensive video production and distribution systems is reduced and passed down to the consumer in a novel way. On time or near real-time reporting, news, commentaries and discoverability of today's and tomorrow's stars will be enabled through competition of a large pool of sports fans who are typically already experts with regards to their favorite and preferred team or teams. Sports fans and eyewitnesses are already on the scene and can produce and distribute the most current news. Sports fans don't have to rely solely on traditional media outlets.

Sports fans build communities for their favorite sports teams. The sports fans are typically geographically concentrated around their favorite teams. Many sports fans go to local sports events of their favorite team when the team plays against another team. When the fans are at the event, they may make videos about this special event. An advantage of embodiments of the inventive method and system is to organize these sports fans (or sports fan communities) and provide them with a platform for sharing sports videos.

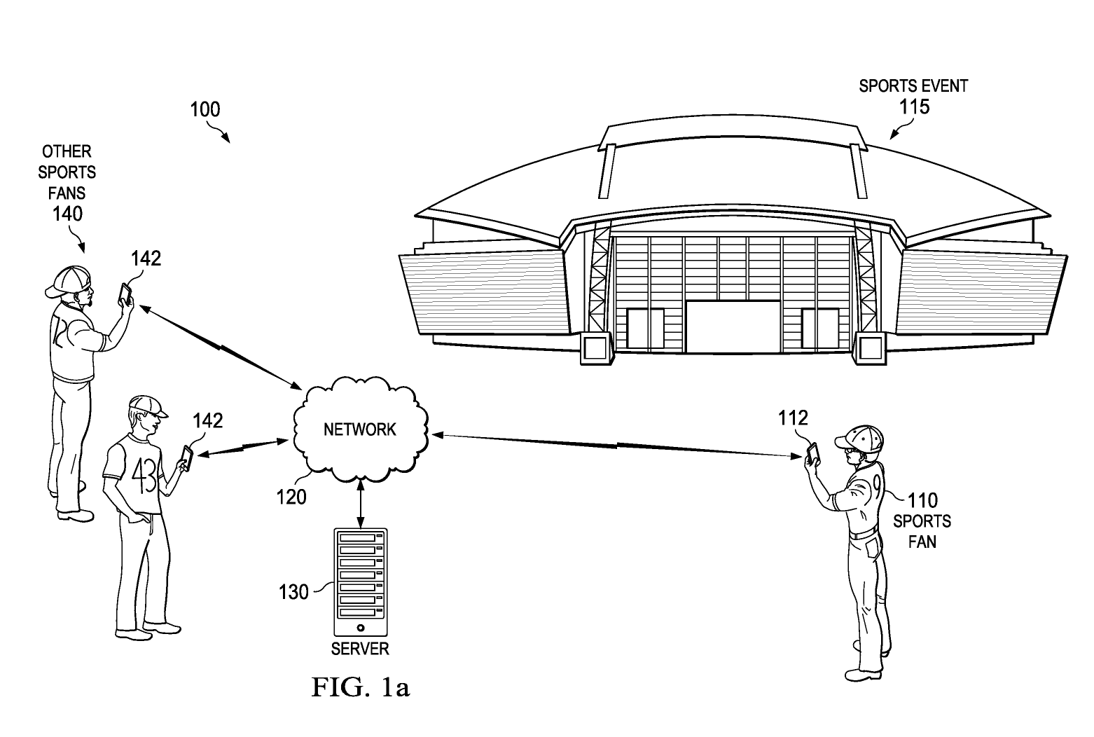

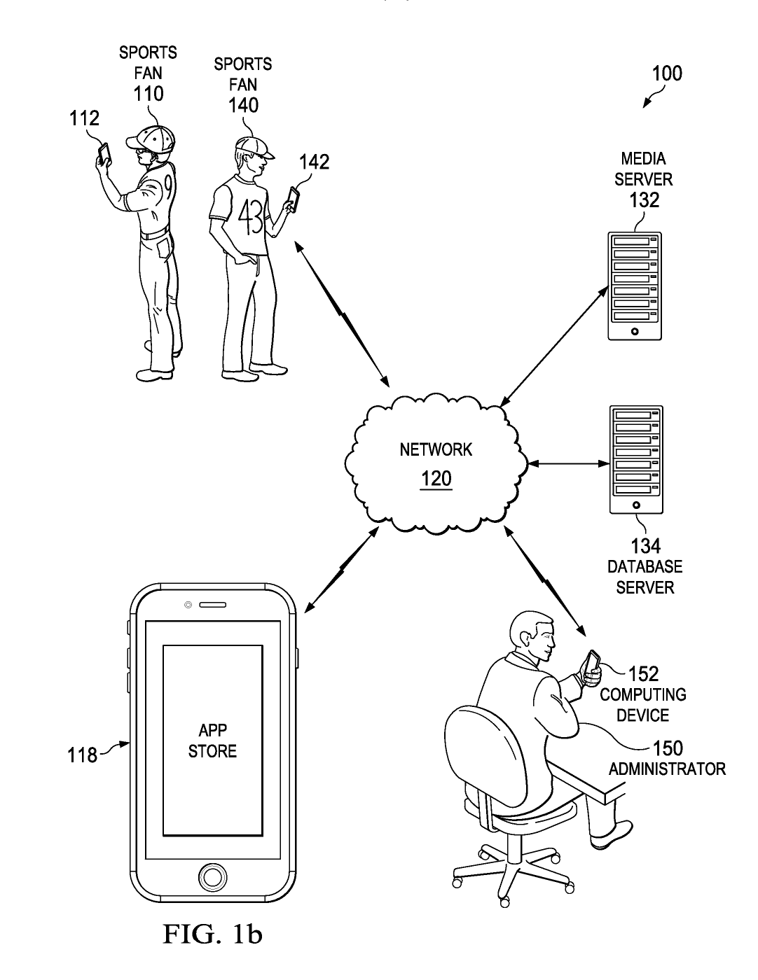

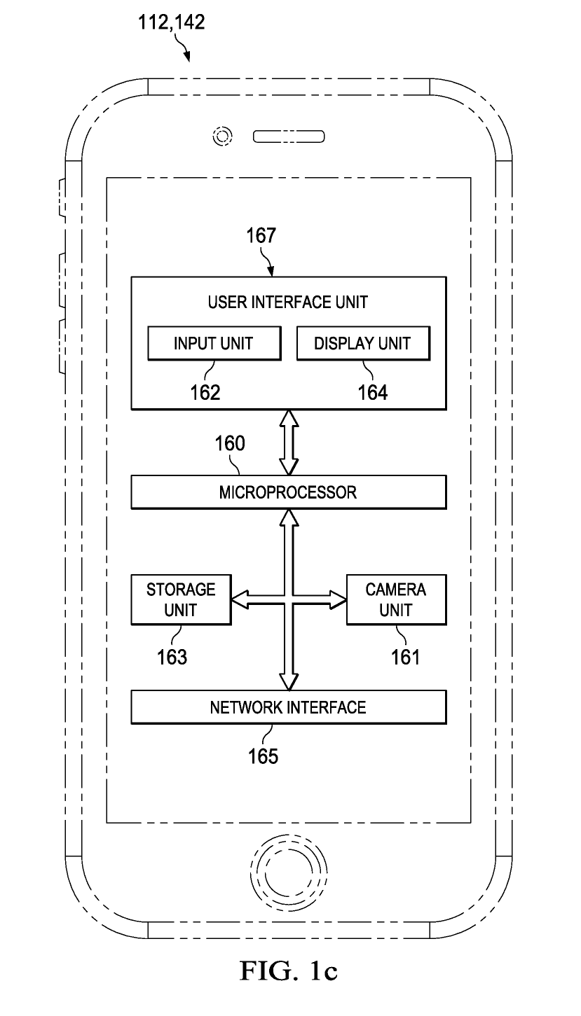

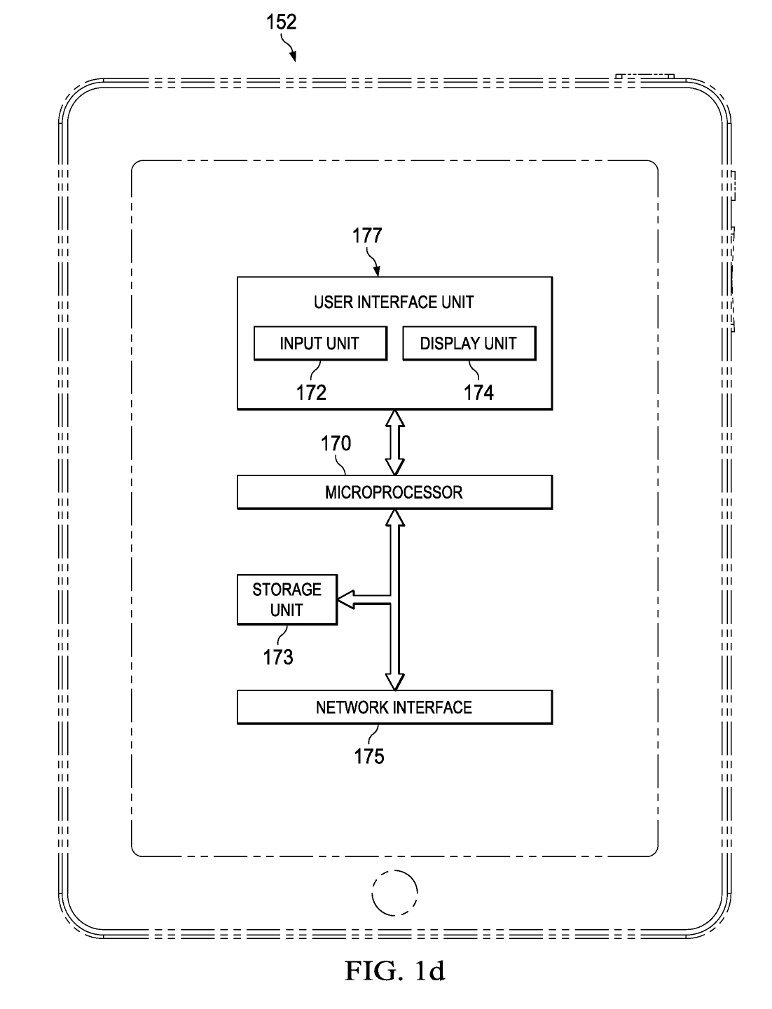

FIG. 1a shows a system 100 comprising a user or sports fan 110 attending a sports event 115. The sports fan 110 may make a video clip from a sports event 115 with a computing device 112. The computing device 112 may be a hand held device such as a cell phone or tablet computer. Alternatively, the computing device 112 may be another mobile device, e.g., a wearable video camera including a microphone (integrated in a jacket or vest, for example) or a wireless camera. The sports fan 110 transmits the video clip over a network 120 to a server 130 (e.g., a media server). Other sports fans or other users 140 can access and watch the video through their computing devices 142 (e.g., hand held devices).

The user or sports fan may function in two different capacities. First, the user or sports fan is a “producer” of videos, video clips, video data or video content. The videos can be made at home while watching TV or out in public alone or with other sports fans. Second, the user or sports fan is a “consumer” or “viewer” of the videos, video clips, video data or video content made by watching these videos made by other uses or sports fans on his computing device. The user or sports fan may be a mobile device video correspondent when producing and uploading videos. The user or sports fan may be a consumer (or viewer) by consuming, watching and commenting on the videos uploaded by other sports fans.

FIG. 1b shows a more detailed Figure of FIG. 1a. The system 100 comprises the users or sports fans 110, 142 having computing devices 112, 142. The computing device 112 of the sports fan 110 may operate a software application or user application for sports media services. The user application for sports media services is a computer program designed to run on computing devices such as cell phones, tablet computers or other mobile devices. The application is typically available through an application distribution platform (e.g., an app store) 118 which may be operated by a mobile operating system developed and maintained by Apple®, for example. The user application for sports media services may be downloaded via the network 120 to the computing devices 112, 142.

The system 100 further comprises a media server 132 and a data base server 134. As described later the sports fans 110, 140 set up their profiles and upload video clips through the computing devices operating the user application for sports media services 112, 142. The profile data of the sports fan 110, 140 are uploaded through the network 120 and stored on or by the data base server 134 and the video data made by the sports fan at home or at a sports event are uploaded through the network 120 and stored on or by the media server 132.

An operator 150 or employee of a sports media company, e.g., Fan Media Network, can see, review, control and monitor the video clips stored in the media server 132 and the profiles (e.g., profile data) stored in the data base server 134 through an administrative application for sports media services (or back end application). The computing device 150 operating the administrative application (software program) may be a hand held device (e.g., a cell phone, or a tablet computer), a laptop computer or a desktop computer. The operator 150 may, among other things, administratively organize or oversee the administrative organization of the (registered) users (e.g., sports fans), select official mobile device video correspondents, and remove inappropriate videos from the media server 132. Additionally, the operator 150 can look at statistical data about all the users. For example, the operator 150 may look at data of the best mobile device video correspondents, look at the activity of individual mobile device video correspondents, promote a mobile device video correspondent to an official mobile device video correspondent, demote an official mobile device video correspondent, or look at flagged videos and remove them from the media server 132 if necessary, for example.

FIG. 1c shows a computing device 112, 142 operating the user application for sports media services thereon (stored in the storage unit 163). The computing device 112, 142 operating the user application on the microprocessor 160 is configured to manage the functions related user application for sports media services. The user application running on the microprocessor 160 is configured to process, operate, and manage instructions received from a user via the input unit 162 of the user interface unit 167 and to display information via a display unit 164 of the user interface unit 167. The user application through the microprocessor 160 is further configured to transmit data to the network 120 (shown in FIG. 1b) and receive data from the network 120 via the network interface unit 165.

The computing device 112 further comprises a camera unit 161 configured to take video clips and provide video data. The video clips or video data may comprise MPEG data or other compressed data. The microprocessor 160 (operating the user application) may store the video data in the storage unit 163 or upload the video data via the network interface 165 to a media server 132 (shown in FIG. 1b). The user application operating on the microprocessor 160 is configured to upload the video data in real time or in near real time (after making the video clip, storing the video clip in storage unit 163 and uploading the video clip on the computing device 112) to the media server 132. Alternatively, the user application is configured to process and edit the video data stored in the storage unit 163. The edited video data stored in the storage unit 163 may be uploaded to the remote media server 132 with a time delay.

The user may make videos of sports events such as football games, basketball games or soccer matches with the camera unit 161 of the computing device 112, 142. For example, the sports fan may visit the game itself or a training session of his favorite local team. The sports fan may sit in the stadium among other fans and record the atmosphere or other fans with his hand held device. The sports fan may interview other fans about their common favorite team, their feelings or their expectations. The sports fan may chat simply about their new unique outfit or about the newest gossip at the stadium. The sports fan may just be funny or may provide insightful information in the video clips. Alternatively, the sports fan may interview and film a player of her favorite team before the player arrives to or leaves after a training session. The sports fan may upload the video clip in near real time through the user application on his hand held device. The sports fan may upload the video later, after he has reviewed and edited it. Alternatively, the sports fan 110 may upload the video in real-time.

The video may be uploaded through a wireless network or a wireline network 120 using the World Wide Web, the http (hypertext transfer protocol) or https (hypertext transfer protocol secure) protocols. The video may be uploaded to a media server 132. The video may be stored in a specific proprietary storage facility local on or in close proximity to the media server 132, or the cloud. The video may be stored on the team channel for a specific sports team of the media server 132 (when an official mobile device video correspondent for that team uploads the video). Each professional and collegiate sports team has such a team channel reserved on the media server 132. If a team channel is selected by a user on his hand held device the videos stored on the team channel in the media server can be watched through the user application by that user.

The video may be stored somewhere else on the media server 132 when the sports fan is not an official mobile device video correspondent. These videos may only show up when the profile of the sports fan is selected through the user application by other users. However, the video may show up on the team channel when the video gets a lot of positive or affirmative votes from other sports fans so that it ranks first, second or third among all uploaded videos for that specific sports team (votes collected within a specific time frame).

Thumbnail video images of uploaded videos are displayed through the user interface 162 on the computing devices 112, 142 and the user can watch the video by selecting the images. The user may watch the videos via streaming through the network 120 or after downloading them on his computing device or other devices such as TVs, computers, wearables (e.g., smart watches) or other video devices.

FIG. 1d shows a computing device 152 operating an administrative application for sports media services thereon (or administrative application portal). The computing device 152 operating the administrative application on the microprocessor 170 is configured to manage the functions related to the user application for all registered users 110, 140, the media server 132 and the data base server 134. The administrative application running on the microprocessor 170 is configured to process, operate, and manage instructions received from an operator via an input unit 172 of the user interface unit 177 and to display information via a display unit 174 of the user interface unit 177. The user application through the microprocessor 170 is further configured to transmit data to the network 120 (shown in FIG. 1b) receive data from the network 120 via the network interface unit 175, and store received data or processed and calculated data in the storage unit 173. The administrative application for sports media services may also be stored in the storage unit 173.

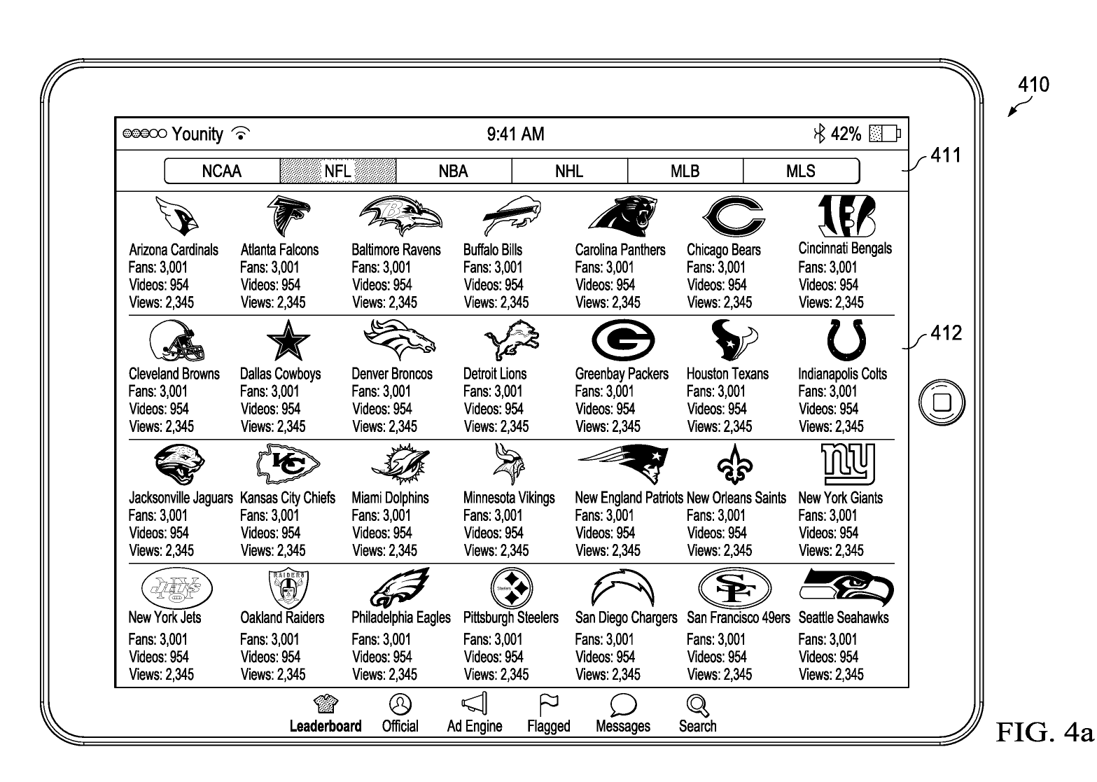

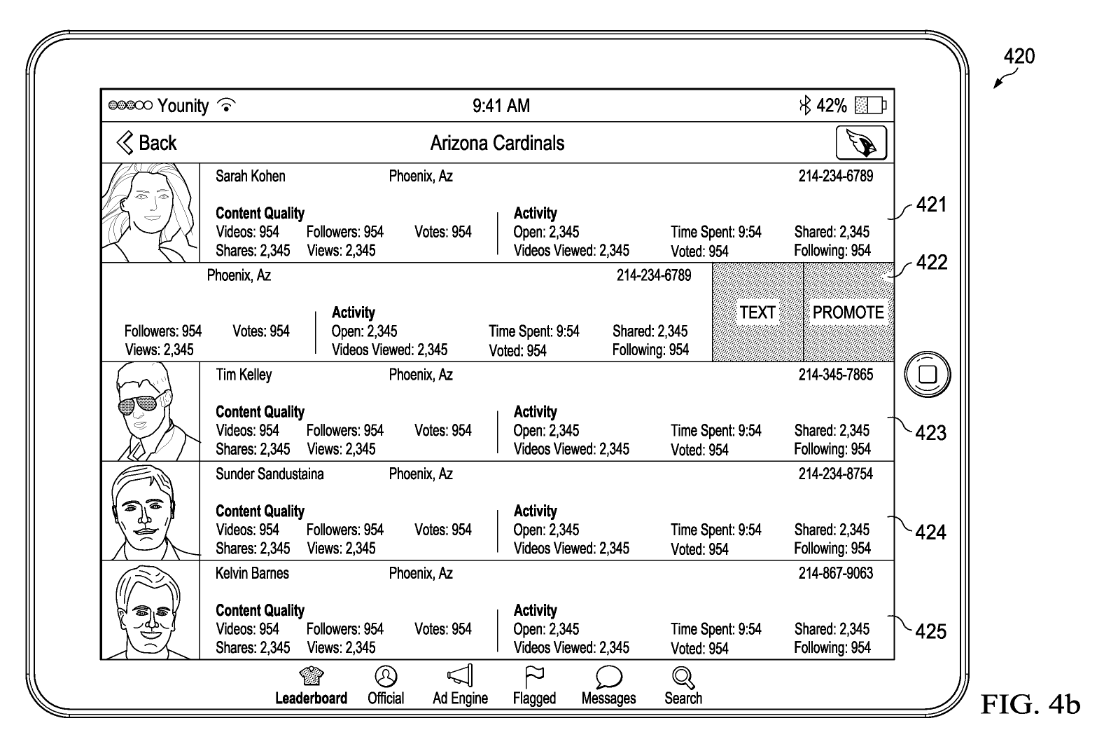

The administrative application may include all the functions of the user application plus additional functions. The administrative application may calculate, determine, evaluate and rank all the registered sports fans 110, 140 according to their performance data. The administrative application may identify the registered sports fans ranked highest for each individual sports team. User interfaces related to the administrative application are shown in FIGS. 4a and 4b.

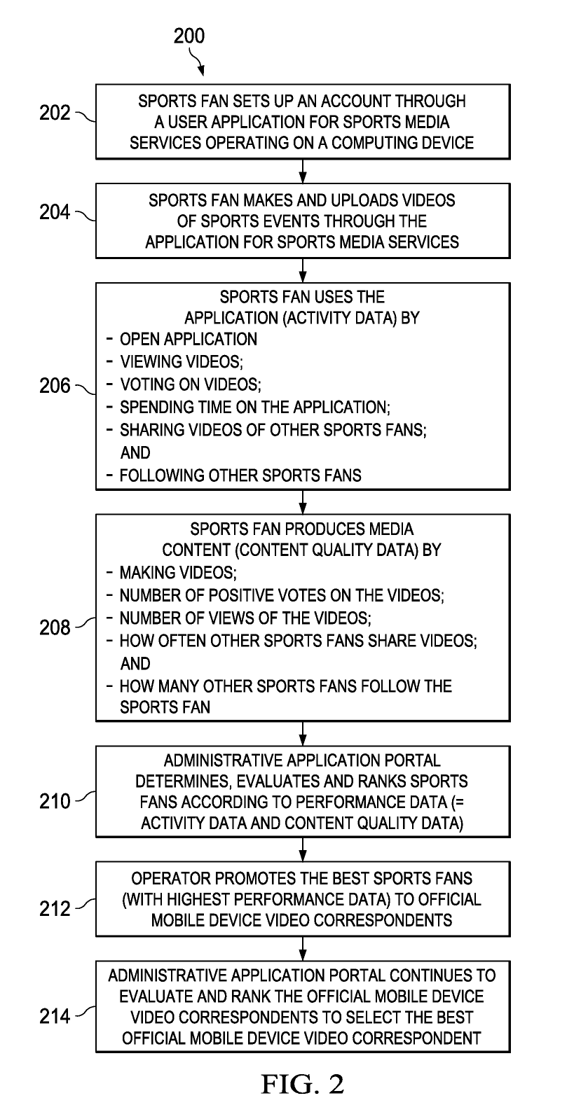

FIG. 2 shows a flow chart 200 for selecting a sports fan (or user) as an official mobile device video correspondent. In the first step 202, the sports fan opens an account through a user application for sports fan (mobile app) that runs on a computing device such as a hand held device. After setting up the account through the mobile app (the account data will be stored on the data base server), the sports fan signs into it.

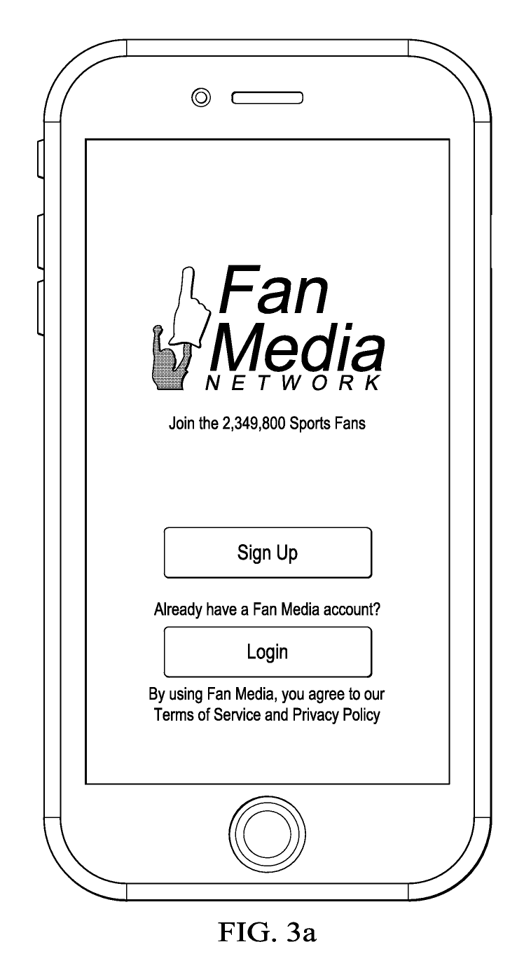

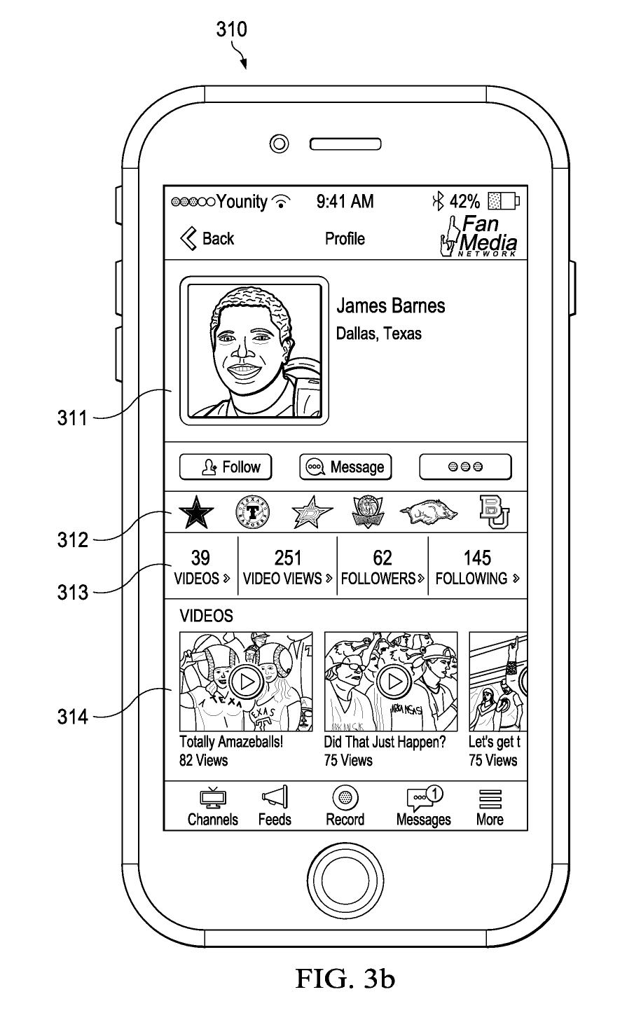

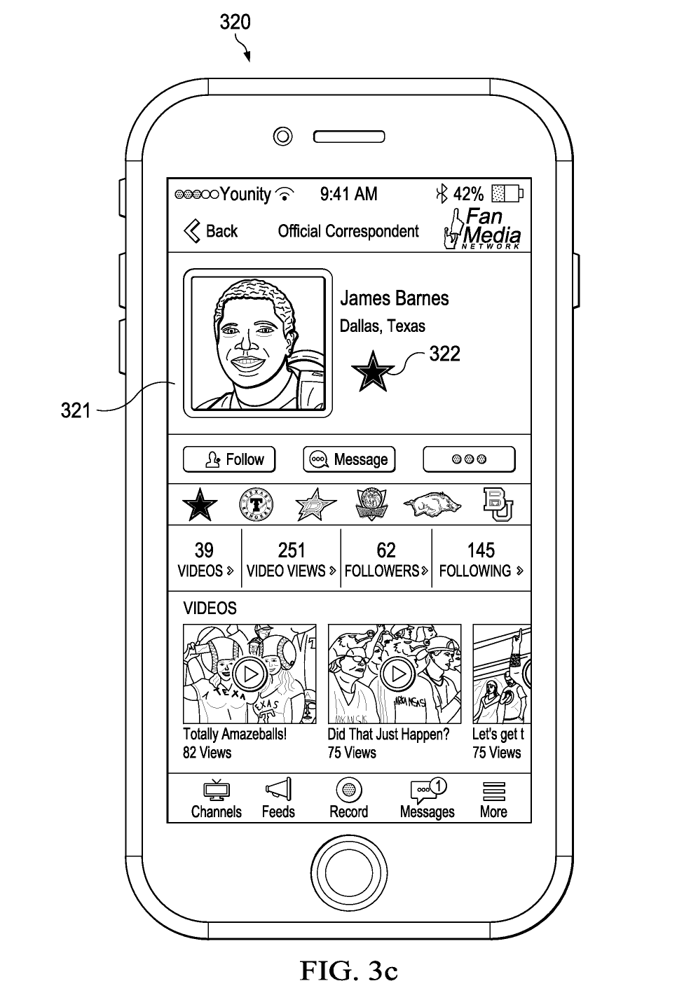

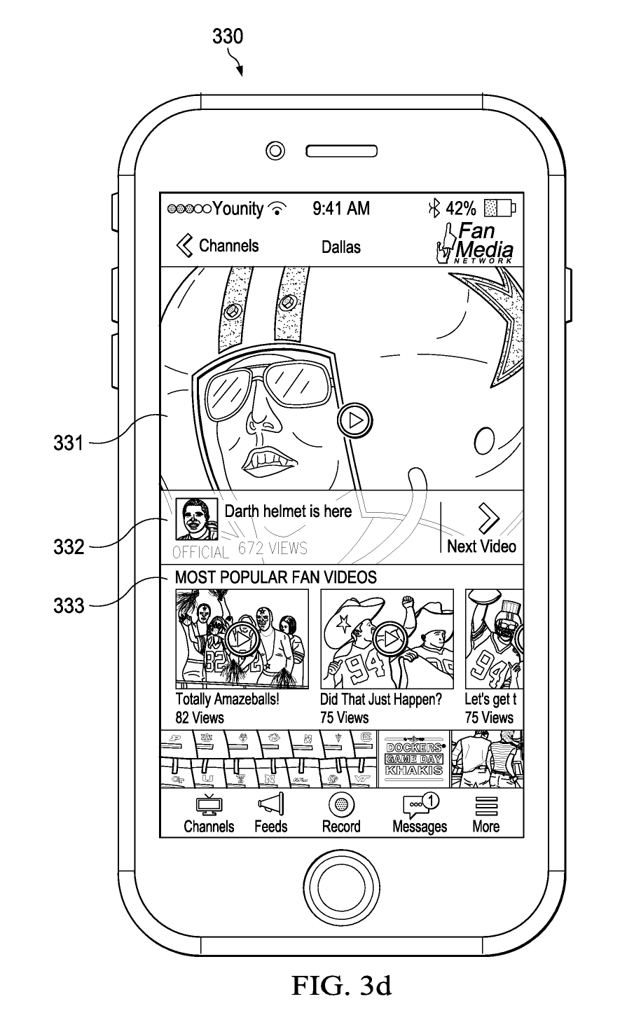

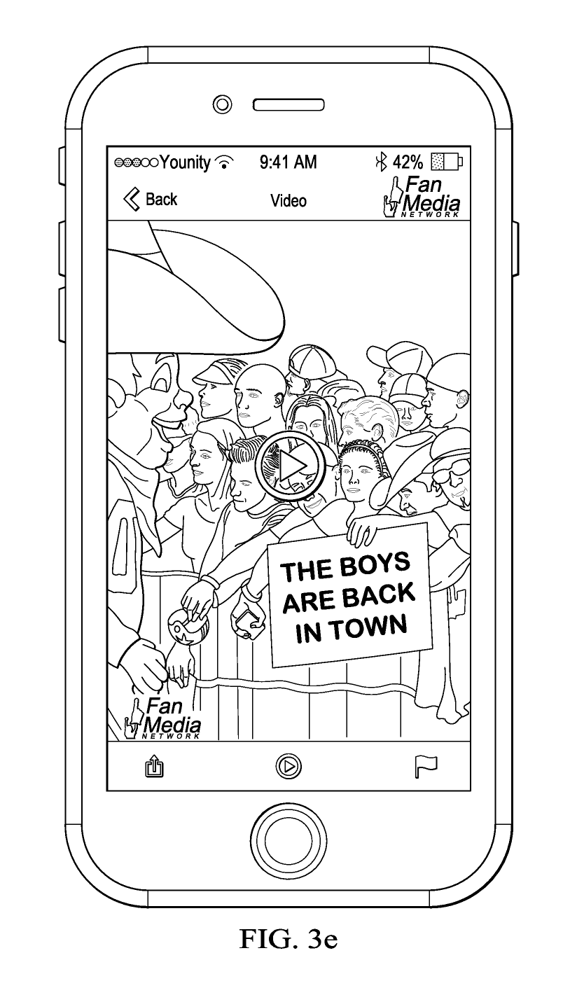

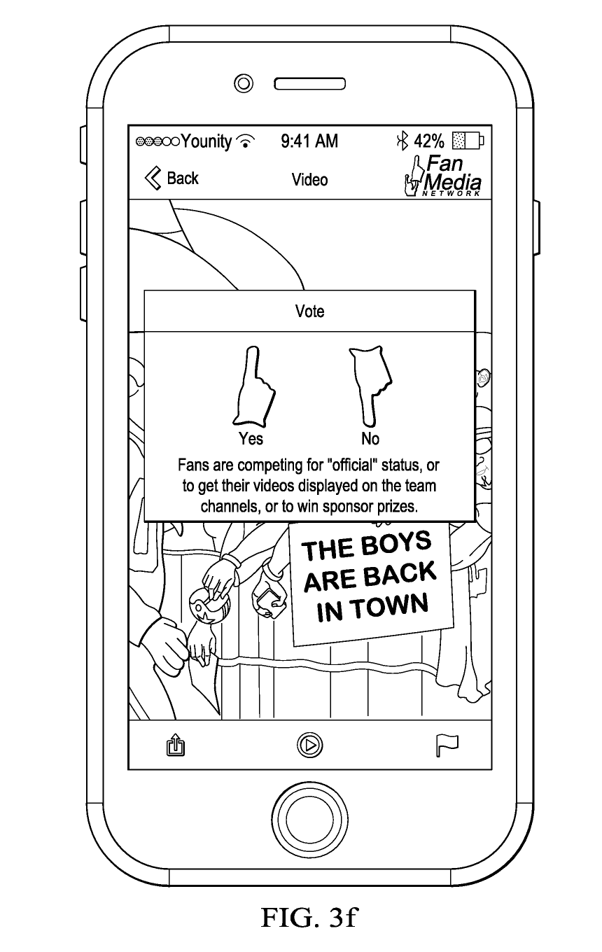

The user application for sports fan supports several user interfaces (UI). FIG. 3a shows an initial user interface for such an application. The sports fan sets up and accesses a user account with user identification ID and password. FIGS. 3b-3f show a series of user interfaces seen by the sports fan after she has signed into the account and selected her favorite team(s).

FIG. 3b shows a user interface 310 showing a profile of a regular user or sports fan 310. As mentioned above, the sports fan may also be described herein as mobile device video correspondent. In the first panel 311 of the user interface 310 the picture of the sports fan is shown. In a second panel of the user interface 310 the favorite teams 312 of the sports fan are displayed. The sports fan can select a plurality of favorite teams. FIG. 3b further shows in a third panel 313 below the panel with the sports fan favorite's teams 312, the leaderboard 313. The leaderboard 313 shows how many videos the sports fan has made (e.g., 39), how many views the videos (made by the sports fan) have received by other sports fans (e.g., 251), how many followers he has or how many other sports fans follow him (e.g., 62) and how many other sports fans he is following (e.g., 145). In the fourth panel 314 of the user interface 310 thumbnail preview video images are shown. These thumbnail preview video images are representatives of the videos the user made and stored at the media server. The most popular videos the sports fan made and uploaded through the user application for sports media services to the media server maybe ranked first. The videos (and therefore the thumbnail images) may be ranked according to the number of views and positive (or yes) votes the videos received. Anyone looking at the interface 310 (e.g., profile of this sports fan) can watch the most popular videos made by this sports fan. The videos can be watched instantly by selecting or activating the thumbnail preview video images shown in the fourth panel 314 of the interface 310. The videos come to full screen and the can be watched. This is shown in FIG. 3e. The videos may have a length of :30-seconds or less. After watching the videos the sports fan who watched the video must vote on the video. This is shown by the user interface in FIG. 3f. The user application for sports media services forces and allows one vote per video. Each user can only vote once per video even if the user sees it several times. In other embodiments the user may vote several times on a video. In some embodiments the panels 311-314 may be arranged in a different order.

FIG. 3c shows a user interface 320 of a sports fan after the sports fan became promoted to the status of official mobile device video correspondent for a specific sports team. The user interface 320 may look similar to the user interface (regular sports fan) 310, i.e., one which is not official mobile correspondent for a sports team. However, above the first panel 321 the user interface 320 indicates that it is a profile of an official mobile device video correspondent. Moreover, next to the sports fan's picture in 321 the sports team or organization 322 is shown for which the sports fan is official mobile device video correspondent (e.g., here the Dallas Cowboys®). The sports fan may become official mobile device video correspondent only for one sports team. Alternatively, the sports fan may become official mobile device video correspondent only for up to two sports teams.

FIG. 3d shows a team channel user interface 330. The first panel 331 of the user interface 330 shows a thumbnail preview video image corresponding to a video clip posted by an official mobile device video correspondent for that team. The thumbnail image may show the latest video posted by an official mobile device video correspondent for that team. Alternatively, the thumbnail image may show the most popular videos of the official mobile device video correspondents of that team over a couple of days such as the last three days or the last week. The sports fan looking at this user interface can look through the latest preview images (i.e., related videos) for this team by touching or selecting the arrow on the middle panel 332. The lower panel 333 of the user interface 330 may show video feeds (thumbnail preview video images) made by sports fans who are not official mobile device video correspondent for that team but rather regular sports fans. The images may be prioritized with the most popular videos (e.g., the ones which received the most votes and views) being displayed first. The sports fan looking at the user interface 330 can scroll the thumbnail images sideward to see the less popular videos. The viewers can select the thumbnail images and watch the videos. Again, a user interface pops up similar to that in FIG. 3e showing the full video. In some embodiments the images in the lower panel 333 are prioritized by positive votes only.

In some embodiments, the videos are of limited durations, e.g., limited to a maximum of :30-seconds or less for videos produced by an mobile device video correspondent and limited, e.g., to a maximum of :60-seconds or less for videos produced by official mobile device video correspondents.

In the next step 204 the sports fan makes and uploads videos of sports events or sports related events through the user application for sports media services operating on their computing device. The sports fan makes these videos or video clips typically for one of his favorite teams or about events related to one of his favorite teams. As described with respect to FIG. 1, the sports fan may attend sports events, may make videos of himself in front of the location where the event takes place, may interview other sports fans, may make a video from the atmosphere at the location, or may interview one of the players of her favorite team. The sports fan uploads these videos (in real time, in near real time, later after editing etc.) through the user application to a media server so that other sports fans can watch the videos through their user application on their computing device.

In step 206 the sports fan is evaluated as a “user” of the user application for sports media services. The activity score of the sports fan is tracked based on activity data in step 206. This is in contrast to the sports fan being a “producer” of video content. The administrative application portal for sports media services collects performance data or key performance parameters (KPI) for each sports fan (e.g., pulls the data from the data base server). The performance data is divided into activity data which are based on several activity measures and content quality data which are based on several content quality measures. The administration application collects activity data for all registered sports fans using the user application for sports media services. The activity data comprise activity measures. The activity measures may be: activity measure 1: the number of times the user has opened an application that runs on the users computing device; activity measure 2: the time the sports fan has spent on the user application; activity measure 3: the number of videos views through the user application; activity measure 4: the number of time the user has voted on these videos through the user application; activity measure 5: the number of times the user has shared these videos with other sports fans through the user application, e.g., via other services such as Facebook®, Twitter®, WhatsApp®, text or email; and activity measure 6: the number of other users the user has followed through the user application. These activities are tracked and summarized as “activity data” by the administration application portal in step 206. There may be more or less than these 6 activity measures. The sports fan's activity data may be calculated based on all activity measures or only on the activity measures (1)-(4). The administrative application portal collects activity data, assigns a weighted value to each activity measure and computes an activity score for the activity data of each sports fan through an algorithm.

The sports fan may follow other sports fans of his favorite team(s) or any team. The sports fan may follow especially those other sports fans who provide good insight and make professional, entertaining videos. The sports fan may communicate with other sports fans of his favorite team(s) or other teams about topics relating to the team or about other things through the user application text messaging system.

In step 208 the sports fan is evaluated as a “producer” of video content (content quality data). The content quality score of the sports fan is tracked based on content quality data in step 208. The content quality data comprise content quality measures. The content quality measures may be: content quality measure 1: the number of videos have been made by the sports fan, content quality measure 2: the number of positive votes the videos made has received, content quality measures 3: the number of views the videos made has receive, content quality measure 4: the number of times the videos made have been shared, and content quality measure 5: the number of followers the sports fan has had. There may be more or less than these 5 content quality measures. The sports fan's content quality data may be calculated based on all quality measures or only on the quality measures (1)-(3). The administrative application portal collects content quality data, assigns a weighted value to each content quality measure and computes a content quality score for the content quality data of each sports fan through an algorithm.

In step 210, the administrative application portal (a software program) running on the computing device determines and ranks the plurality of sports fans according to their performance data, i.e., according to their content quality data and activity data. In determining the performance, the administrative application may pull these data from the data base server. The performance data may be calculated as the content quality data multiplied with an associated weighting factor added by the activity data multiplied with an associated weighting factor. In some embodiments the associated weighting factor of the content quality data and the associated weighting factor of the activity data may be equal. In alternative embodiments the associated weighting factor of the content quality data is higher than the associated weighting factor of the activity data. For example, the weighting factor of the content quality data is ⅔ and the weighting factor for the activity data is ⅓ or the weighting factor of the content quality data is ¾ and the weighting factor of the activity data is ¼.

In other embodiments the activity measures within the activity data also include weighting factors. The activity data may be calculated by multiplying an activity measure with the respective activity weighting factor and add together the results of the multiplication for each activity measure. For example, the activity weighting factor for the activity measures 1-4 may be the same (e.g., each is 3) while the activity measures 5-6 may have lesser activity weighting factors. The activity weighting factor for the activity measure 5 may be 2 and the activity weighting factor for the activity measure 6 may be 1. Similarly, the content quality measures within the content quality data may also include weighting factors. The content quality data may be calculated by multiplying a content quality measure with the respective content quality weighting factor and add together the results of the multiplication for each content quality measure. For example, the content quality weighting factor for the content quality measures 1-3 may be the same (e.g., each is 3) while the content quality measures 4-5 may have lesser content quality weighting factors. The content quality weighting factor for the content quality measure 4 may be 2 and the content quality weighting factor for the content quality measure 5 may be 1.

There may be more than 1,000,000 registered sports fans, more than 10,000,000 registered sports fans or more than 100,000,000 registered sports fans. The method is able to filter out the best sports fans of an extremely large number of sports fans and provide the selected sports fans with new opportunities.

After organizing, evaluating, ranking and identifying the sports fans through the administrative application portal a sports fans with the highest performance score for an individual sports team (the “best” sports fans) may be promoted from mobile device video correspondents to official mobile device video correspondents for the individual sports team (step 212). The promotion is made by contacting the selected sports fan(s) automatically by the administrative application portal or by an operator. The sports fan may receive a phone call, a text message or a message through the in-app messaging system.

In some embodiments the sports fan may only be promoted to official mobile device video correspondent for an individual sports team if the sports fan lives within a defined geographical area around that sports team. A sports fan may not be promoted even if she is ranked highly (has a very high performance score) among other sports fans for a specific sports team if she does not live within a defined geographical area of that sports team. Moreover, a sports fan who is official mobile device video correspondent for one team remains a regular mobile device video correspondent with respect to other sports teams. In some embodiments, the sports fan who is official mobile device video correspondent for one team is excluded for being an official mobile device video correspondent for another team. Alternatively, the sports fan may be official mobile device video correspondent for maximal two teams. In some embodiments the sports fan who is official mobile device video correspondent may lose his status if he moves outside of the defined geographical area of that sports team.

As mentioned above a sports fan may only become official mobile device video correspondent for a specific team when she lives geographically close to this team. For example, the sports fan can become official mobile device video correspondent for the Dallas Cowboys® when she lives within a radius of 75 miles of the Dallas Cowboys® (e.g., the stadium of the Dallas Cowboys®, the headquarters of the Dallas Cowboys® or the city center of Dallas). Alternatively, the sports fan can only become official mobile device video correspondent when she lives within a radius of 100 miles or a radius of 150 miles. In other embodiments the radius depends on the density of the population where the sports team is located. The sports fan selected to be official mobile device video correspondent may live within a shorter radius for a team in a densely populated area but may live within a larger radius for a team in a more sparsely populated area. Living may mean having a residence, or having a primary residence. Alternatively, living may mean the address provided when the sports fan registers himself through the user application.

The operator may be able to demote an official mobile device video correspondent to a (regular) mobile device video correspondent if his performance declines. For example, the former official mobile device video correspondent does not make enough videos anymore, makes only average videos instead of excellent and insightful videos or the official mobile device video correspondent cannot accumulate the number of viewers for his videos anymore.

The evaluation and identification of the best official mobile device video correspondent for a team may be made for one season (the length of a season can be different for different sports leagues). The competition for becoming an official mobile device video correspondent may be restarted after the season has ended and before the start of the new season. In some embodiment all official mobile device video correspondents (alternatively, more than 80% of the official correspondents; more than 90% of the official correspondents or between 80% and 90% of the correspondents) may be reset to (regular) mobile device video correspondents by the administrative application portal after the season ended for a particular sports team for which the sports fans were selected as official mobile device video correspondents. Accordingly, all sports fans or the majority of sports fans are only (regular) mobile device video correspondents when the new season starts for that sports team and the evaluation and selection process starts anew. In alternative embodiments, the evaluation and identification of the best official mobile device video correspondents for a team may be made for several seasons (e.g., three seasons).

In step 214, the administrative application portal continues to evaluate and rank the official mobile device video correspondent to select the best official mobile device video correspondents. The selection may be made according to the same parameters identified earlier or according to additional parameters.

The best official mobile device video correspondent may be considered to be selected or hired by other media companies, brands and networks. For example, these official mobile device video correspondents can be selected to be experts for a specific team for radio and TV shows, to be correspondents for a specific team or to be (assistant) moderators. Moreover, the best official mobile device video correspondent may be eligible for free tickets, media credentials or products and services. The selection for job opportunities, tickets or media credentials may be made directly to the official mobile device video correspondent or through Fan Media Network.

The sports fans may compete to be promoted to official mobile device video correspondent. The sports fans may compete so that their videos are voted up and displayed on their favorite team's channel. The sports fans may compete to win, earn or receive sponsor products and services, such as special access to sports events and or media credentials. Moreover, the sports fans may earn money through syndication. For example, another media outlet likes to air a video made by a sports fan and voted up by sports fans using the user application. The media outlet may contact the operator who negotiates the contract for showing the video by the media outlet. Consideration may be transferred to the sports media company for using and showing the video and a portion of this consideration may be forwarded to the sports fan having made the video. The sports fan may compete to get lucrative and interesting employment. In an embodiment a successful sports fan may be asked to produce a video on behalf of a brand. For example, an official mobile device video correspondent may make a :30-second video about his favorite team and a product of the brand.

FIGS. 4a-4b shows a series of user interfaces displayed on the display unit of the computing device 150 of operating the administrative application portal and seen by an operator. FIG. 4a shows a first user interface 410 for providing information for an operator. In the top panel 411 the different sports leagues are displayed (e.g., NCAA, NFL, NBA, etc.) and in the middle panel 412 the teams for the individual sports leagues are shown, in this particular example, the teams of the NFL. The panels 411, 412 may be arranged in a different order. The user interface provides an overview of how many registered fans a sports team has, how many videos have been made for the specific sports team and how often the videos have been viewed.

FIG. 4b shows a second user interface 420 providing information for the operator. This user interface 420 shows individual sports fans ranked according to their quality content (data) and activity (data). The sports fan with the best performance (i.e., the highest quality content and the highest activity) is ranked first and the sports fan with the next best performance is ranked second and so forth. The sports fan may be ranked according to the parameters described with respect to steps 206-210 of FIG. 2. The calculation for the ranking may be made by the administrative application portal operating on the microprocessor of the computing device 152 (see FIG. 1b). The administrative application may collect information stored on the media server and data base server to provide the rankings of the registered sports fans. In this particular example, the user interface shows the ranking of the sports fans for the Arizona Cardinals®. The computing device running on the administrative application may show a user interface for any team of any sports league.

As can be seen from FIG. 4b, the user interface provides content quality and activity information of individual sports fans. For example, the highest ranked sports fan for the Arizona Cardinals® is shown in panel 421, the second highest ranked sports fan for the Arizona Cardinals® is shown in panel 422 and other high ranked sports fans for that sports team are shown in panel 423-425. The individual content quality measures and activity measures are shown for each sports fan. These high ranked sports fans may all be promoted to official mobile device video correspondents. FIG. 4b shows how panel 422 moves to the left when selected by an operator in order to promote this sports fan to official mobile device video correspondent (text box “promote”). At the same time or independently the operator can send an in-app text message to the selected sports fan.

Accordingly, the administrative application or the operator may promote the sports fan ranked first to an official mobile device video correspondent for the sports team he is ranked highest. The administrative application or the operator may promote other sports fans ranked high according to their performance score to official mobile device video correspondent for this specific team. The operator may select the best official mobile device video correspondent for any team for additional opportunities.

Embodiments of the invention provide methods that enable operators to select the best, most knowledgeable and active sports fans for each individual sports teams. The sports teams may utilize the sports fans for various purposes.

Embodiments of the invention may be extended beyond sports fans to fans in general and beyond sports teams to subjects in generals. For example, embodiments of the invention contemplate music fans making videos about their favorite bands, fans of actors about their favorite actors and their favorite TV series. Embodiments include any media where the viewers vote, determine and evaluate the correspondents or reporters, etc.

Some embodiments of the invention include a non-transitory computer-readable storage medium encoded with a computer program (e.g., user application for fan media services or the administrative application portal for fan media services) comprising instructions that, when executed by data processing apparatus, cause the data processing apparatus to perform the functions described supra.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A computer-implemented method, the method being performed on a computing device and comprising:
collecting content quality data for a plurality of users, wherein the content quality data for each user is calculated from the following content quality measures:
(1) a number of videos made by the user;
(2) a number of positive votes received for the videos made by the plurality of users;
(3) a number of views for the videos made by the plurality of users;
(4) a number of times the videos made is shared by other users; and
(5) a number of other users following the user; and
determining and ranking the plurality of users according to the collected content quality data.

2. The method according to claim 1, further comprising identifying a highest ranked user of the plurality of users and promoting the identified user to an official mobile device video correspondent.

3. The method according to claim 2, wherein identifying the official mobile device video correspondent comprises identifying the official mobile device video correspondent for a single sports team.

4. The method according to claim 3, wherein the official mobile device video correspondent lives within a radius of 100 miles of the single sports team.

5. The method according to claim 1, wherein each content quality measure has an associated weighting factor, and wherein the associated weighting factors for the content quality measures (1)-(3) have the same first factor, and wherein associated weighting factors for the content quality measures (4)-(5) have second factors, the second factors being lower than the first factor.

6. The method according to claim 5, wherein the first factor is 3, wherein the second factor for the content quality measure (4) is 2, and wherein the second factor for the content quality measure (5) is 1.

7. The method according to claim 1, wherein the plurality of users is greater than 1,000,000.

8. The method according to claim 1, wherein the plurality of users is a plurality of sports fans.

9. A method for operating a computing device, the method being performed by a processor and comprising:
producing a video clip of an event of a team via a camera of the computing device;
uploading as part of an application that runs on the computing device, via an input device, the video clip to a server;
displaying a user interface as part of the application, on a display unit, image data related to the uploaded video clip, wherein the user interface includes a first panel and a second panel, wherein the image data is displayed in the first panel when the user is an official mobile device video correspondent and when the video clip was uploaded as a latest video clip, and wherein the image data is displayed in the second panel when the user is not an official mobile device video correspondent and when the video clip receives more views from a plurality of users than other video clips made with respect to the same team.

10. The method according to claim 9, wherein the user is a sports fan, and wherein the team is a sports team.

11. The method according to claim 9, wherein the video clip has a length of :60-seconds or less when the user is the official mobile device video correspondent, and wherein the video clip has a length of :30-seconds or less when the user is not an official mobile device video correspondent.

12. The method according to claim 9, wherein the plurality of users is greater than 1,000,000.

13. A computer-implemented method, the method being performed on a computing device and comprising:
collecting content quality data for a plurality of users, wherein the content quality data for each user is calculated from the following content quality measures:
(1) a number of videos made by the user;
(2) a number of positive votes received for the videos made by the plurality of users;
(3) a number of views for the videos made by the plurality of users;
(4) a number of times the videos made is shared by other users; and
(5) a number of other users following the user;
collecting activity data for the plurality of users, wherein the activity data for each user is calculated from the following activity measures:
(6) a number of times the user has opened an application that runs on the users computing device;
(7) a time spent the application;
(8) a number of videos viewed;
(9) a number of videos voted on;
(10) a number of videos shared;
(11) a number of other users the user followed;
calculating performance data for each user based on the content quality data and activity data; and
determining and ranking the plurality of users according to the collected performance data.

14. The method according to claim 13, wherein the activity data has an associated activity weighting factor and wherein the content quality data has an associated content quality weighting factor, and wherein both factors are equal.

15. The method according to claim 14, wherein each content quality measure has an associated weighting factor, wherein the associated weighting factors for the content quality measures (1)-(3) have the same first factor, wherein associated weighting factors for the content quality measures (4)-(5) have second factors, the second factors being lower than the first factor, wherein each activity measure has an associated weighting factor, wherein the associated weighting factors for the activity measures (1)-(4) have the same third factor, and wherein associated weighting factors for the activity measures (5)-(6) have fourth factors, the fourth factors being lower than the third factor.
